(19) United States
(12) Patent Application Publication
(10) Pub. No.: US 2026/0111556 A1
(43) Pub. Date: Apr. 23, 2026

(54) IDENTIFICATION OF USERS OF SYSTEMS

(71) Applicant: Kyndryl, Inc., New York, NY (US)

(72) Inventors: Cesar Augusto Rodriguez Bravo, Alajuela (CR); Chris Bode, Holly Springs, NC (US); Kim A. Eckert, Austin, TX (US)

(21) Appl. No.: 18/918,822

(22) Filed: Oct. 17, 2024

(51) Int. Cl. G06F 21/57

(52) U.S. Cl. CPC G06F 21/577; G06F 2221/034

(57) ABSTRACT

A computer-implemented method includes: obtaining, by a computing device, location information of a user attempting to gain access to a system; generating, by the computing device, a plurality of images from the location information, the plurality of images including at least one image representative of the location of the user; presenting, by the computing device, the plurality of images to the user; validating, by the computing device, the user by determining that the user has selected the at least one image representative of the location information of the user; and allowing, by the computer device, the user to access the system based on the user being validated.

### BACKGROUND

Aspects of the present invention relate generally to an identification/validation system and, more particularly, to a system, method of use and related computer program product to identify and validate users attempting to access an account or system.

Automated Bots are a growing issue in Cybersecurity. The Bots cause disruption at almost any level, including Bot net attacks, saturation of services, etc. Additionally, automated bots are becoming ever smarter every day, which increases vulnerability risks.

### SUMMARY

In a first aspect of the invention, there is a computer-implemented method including: obtaining, by a computing device, location information of a user attempting to gain access to a system; generating, by the computing device, a plurality of images from the location information, the plurality of images including at least one image representative of the location of the user; presenting, by the computing device, the plurality of images to the user; validating, by the computing device, the user by determining that the user has selected the at least one image representative of the location information of the user; and allowing, by the computer device, the user to access the system based on the user being validated.

In another aspect of the invention, there is a computer program product including one or more computer readable storage media having program instructions collectively stored on the one or more computer readable storage media. The program instructions are executable to: validate a device as being a trusted device; determine location information of a user of the device; generate an image that is representative of the location information of the user and at least one other image that is not representative of the location information of the user; present to the user the image that is representative of the location information of the user and the at least one other image that is not representative of the location information of the user; and allow access to a system when the device has been validated as trusted and the user has selected the image that is representative of the location information of the user.

In another aspect of the invention, there is system including a processor, a computer readable memory, one or more computer readable storage media, and program instructions collectively stored on the one or more computer readable storage media. The program instructions are executable to: determine a location of a user using device information; obtain a picture of the location; generate an image of the picture that is representative of the location of the user; present to the user the image that is representative of the location of the user and images of other locations; and allow access to a system when the user has selected the image that is representative of the location of the user.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment in accordance with aspects of the invention.

FIG. 5 shows a street view of a location of a user in accordance with aspects of the invention.

FIGS. 6-9 show representative street views generated by an image-to-image generative artificial intelligence engine.

FIGS. 10-12 show different flowcharts of exemplary methods in accordance with aspects of the invention.

### DETAILED DESCRIPTION

Aspects of the present invention relate generally to an identification/validation system and, more particularly, to a system, method of use and related computer program product to identify and validate users attempting to access an account or system. In embodiments, the account or system can be a web-based system, for example, which would otherwise use a CAPTCHA system for such user validation. As should be understood by those of skill in the art, CAPTCHA is an acronym that stands for “Completely Automated Public Turing test to tell Computers and Humans Apart.” In embodiments, the system, method of use and related computer program product will be able to thwart or prevent an automated bot from trying to validate a user. For example, aspects of the present invention leverage user visual confirmation from its surroundings to perform human (anti-bot) validations.

As should be understood by those of skill in the art, a CAPTCHA test is designed to determine if an online user is a human and not a bot. Users often encounter CAPTCHA and reCAPTCHA tests on the Internet when trying to access web-based systems. These tests are thus a way of managing bot activity, for example. CAPTCHA, though, has its drawbacks. For example, although CAPTCHA may block some automated bots, it can still be circumvented by some advanced bots. In addition, CAPTCHA involves asking users to identify distorted letters or pictures within multiple boxes, sometimes a task that is even difficult for the user. Accordingly, a user may require several CAPTCHAs to finally be validated. This can be tedious and time consuming. The aspects of the present invention, though, provide a technical feature (e.g., technical solution) to this technical problem with a practical application of validating a user to gain access to a web-based system and which can also prevent access to the web-based system by an automated bot without the use of CAPTCHA.

For example, in implementation, the system, method of use and related computer program product may validate a device as trusted, obtain the user location, gather pictorial information about the user location, generate pictures with one such picture being representative of the user location, and provide such pictures to the user for their selection. In embodiments, the initial validation of the device can be performed using hardware validation or digital validation. If the device cannot be validated, a second validation can be performed by biometrics, passwords, etc.

The system, method of use and related computer program product may obtain the location of the user by an IP address or GPS, as examples. Knowing the user location, the system, method of use and related computer program product can gather location information such as a street view of the user location and, using this information, can parse the information within the street view, e.g., buildings, landmarks, etc., and provide such information to an image-to-image generative artificial intelligence (AI) engine. The image-to-image generative artificial intelligence (AI) engine can generate an accurate representation of the user location, in addition to several fake (artificial or random) images that do not represent the location of the user. The user can select the correct image for validation and to gain access to the web-based system. In this manner, implementations of the invention can leverage user visual confirmation from its surroundings to gain access to an account of a web-based system, which visual confirmation cannot otherwise be identified by automated bots. Hence, the system, method and computer program product provide a technical solution and a practical application to a technical problem.

It should be understood that, to the extent implementations of the invention collect, store, or employ personal information provided by, or obtained from, individuals (for example, user identification) such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

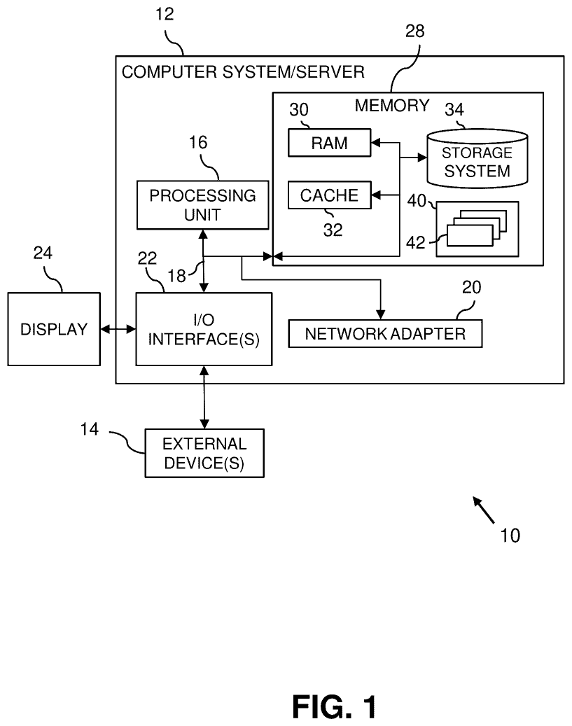

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system.

Generally, program modules may include routines, programs, objects, components, logic, data structures, and so on that perform particular tasks or implement particular abstract data types.

Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

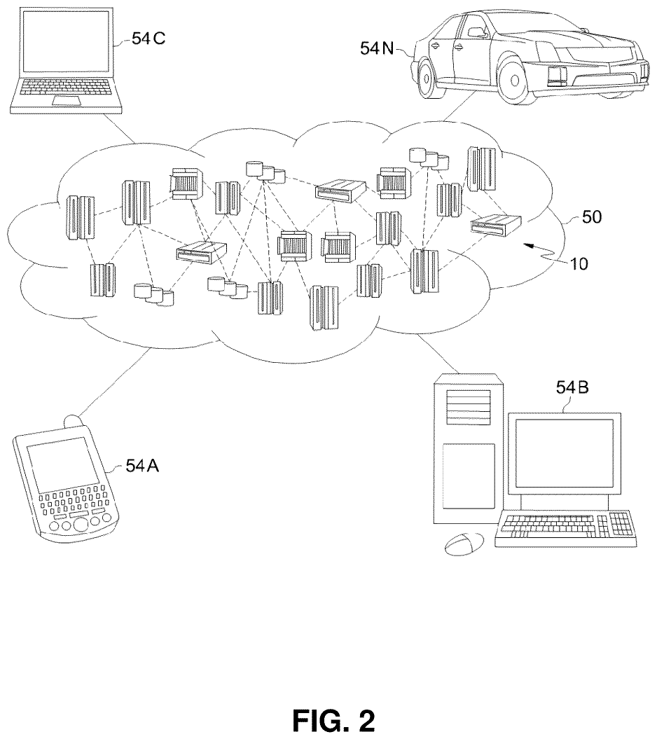

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

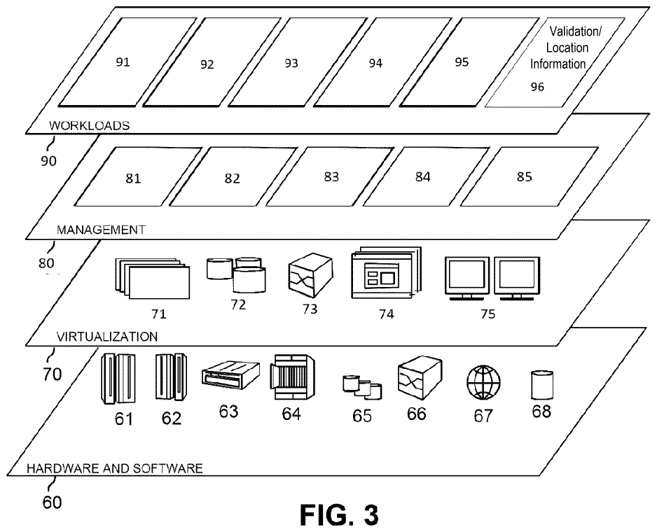

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and validation/location information 96.

Implementations of the invention may include a computer system/server 12 of FIG. 1 in which one or more of the program modules 42 are configured to perform (or cause the computer system/server 12 to perform) one of more functions of the validation/location information 96 of FIG. 3. For example, the one or more of the program modules 42 may be configured to: (i) validate a device as being a trusted device; (ii) determine a location of the user of the device; (iii) obtain information from a street view of the location and provide the information to an image-to-image generative AI engine; (iv) generate different versions of the street view, with one version being a representative depiction of the location of the user and the other versions being non-representative of the location of the user (e.g., artificial images); (v) provide the images to the user of the device; and (vi) upon the user selecting the image which is a representative depiction of the location of user, allow access to the system.

In embodiments, the validation of the device as being trusted can be performed by hardware validation or digital validation. For example, a hardware validation may include using a device serial number or a device MAC address. The digital validation may be, for example, an SSID name that is registered as trusted, a telephone number that is registered as trusted, a SIM card that is registered as trusted, or a trusted geolocation (i.e., a correlation between the device location and previously registered GPS location), as a few examples.

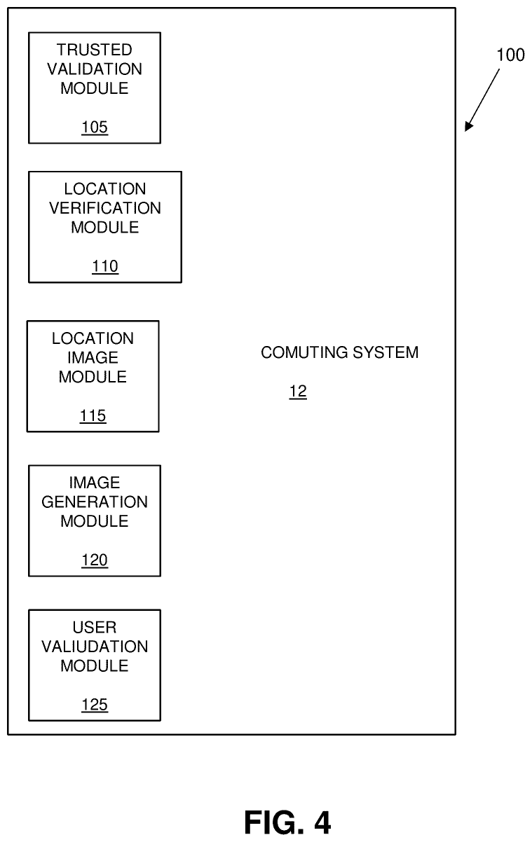

FIG. 4 shows a block diagram of an exemplary environment in accordance with aspects of the invention. In embodiments, the environment 100 includes a trusted validation module 105, a location verification module 110, a location image module 115, an image generation module 120 and a user validation module 125. In embodiments, the computer system/server 12 of FIG. 1 comprises the modules 105, 110, 115, 120, 125, each of which may comprise one or more program modules such as program modules 42 described with respect to FIG. 1. The computer system/server 12 of FIG. 1 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment 100 may include additional devices and/or networks; fewer devices and/or networks; different devices and/or networks; or differently arranged devices and/or networks than illustrated in FIG. 4.

By way of example, the trusted validation module 105 may validate the user device as being a trusted device. This can be done by use of the hardware or digital validation (verification) processes as described herein. In addition, the trusted validation module 105 may validate the user device as being a trusted device using secondary validation processes in the case that the device could not be validated using the hardware of digital validation processes. For example, the secondary validation process may include an authenticator application, multifactor authentication, biometrics or username/password as some examples. As should be understood by those of skill in the art, an authenticator application may provide an extra layer of security to online accounts by generating one-time passwords (TOTPs). These passwords may be used with two-factor authentication (2FA) to prevent unauthorized access.

The location verification module 110 may obtain the location of the user. For example, the location verification module 110 may use the IP address of the device or the actual location of the device. In case of VPN usage where the IP address of the device may not be accessible, for example, the location verification module 110 may use GPS coordinates. In an aspect of the invention, the system may implement super user (elevated) permissions to gather GPS location directly from an OS call to the hardware of the device without asking the user for permissions, as an example. In addition, the location verification module 110 may obtain coordinates of the user, e.g., N XXX.YYY.ZZ-AAA.BB.CC (town and country information). This may be done by converting the actual location of the device to coordinates as is known by those of skill in the art. In further embodiments, the location verification module 110 may identify locations that may be familiar to the user. This may be done by querying the user's device about the user's travel history, contact details (e.g., address and location of contacts), images on the device, transactions, e.g., credit card transactions, etc.

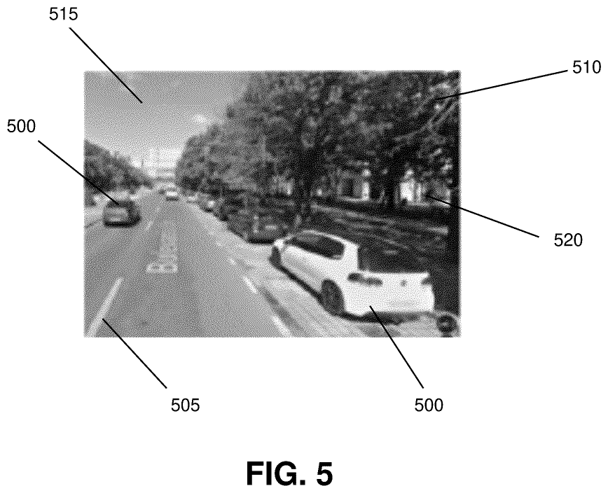

The location image module 115 may obtain the above information from the location verification module 110 and, using this information, may obtain or capture images of the location. These images may be landmarks, buildings, street views of the location etc., as shown in FIG. 5, for example. The location image module 115 may obtain or capture the images of the location using known applications such as, for example, street view maps that are accessible via the Internet. In aspects of the invention, the location image module 110 can parse or identify the real images on the street view maps such as, for example, cars 500, lines on a road 505, trees 510, sky 515 and buildings 520 and their relationships to one another, e.g., location and/or distance, amongst other information as shown representatively in FIG. 5.

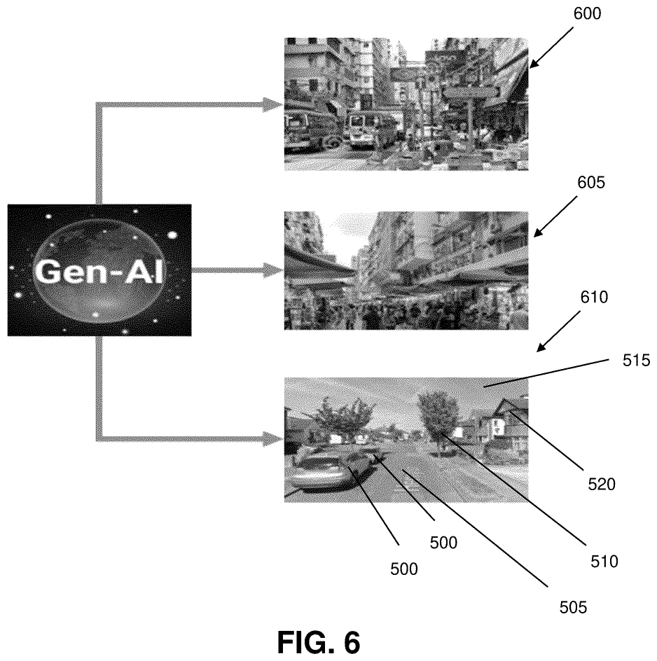

The image generation module 120 may implement an image-to-image generative artificial intelligence (AI) engine or a text-to-image generative artificial intelligence (AI) engine as is known in the art to generate images for subsequent validation. For example, an image-to-image generative artificial intelligence (AI) engine or an text-to-image generative artificial intelligence (AI) engine will use the information obtained from the location image module 115 to create images of the actual location of the user. The images of the actual location of the user will be a fair representation of the actual location of the user. For example, one of the generated images would be familiar to the user as the current location of the user. In addition, the images generated from the image generation module 120 may be other images that are not representative of the user's location or familiar to the user. For example, FIG. 6 shows three images 600, 605 and 610, where image 610 is an image generated from the information obtained from the location image module 114, e.g., fair representation of the actual user location using a street view. Specifically, image 600 shows the cars 500, lines on a road 505, trees 510, sky 515 and buildings 520 and their relationships to one another, e.g., location and/or distance, amongst other information, that are similar to the image shown in FIG. 5. In comparison, the images 600, 605 are artificial or fake images that would be recognized by the user as inaccurate representations of the user's location.

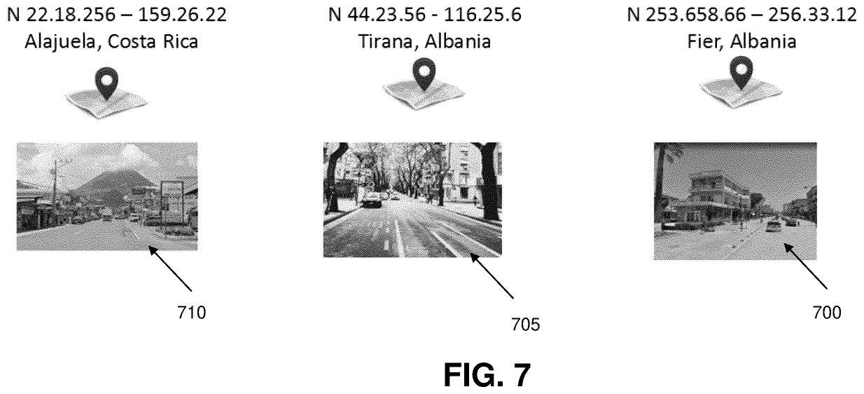

In an alternative embodiment, the image generation module 120 may use coordinate systems to generate images as shown in FIG. 7. The images 700, 705 shown in FIG. 7 may be images of random locations generated or obtained by the image generation module 120; whereas the image 710 may be representative of an actual location of the user. These images 700, 705, 710 may be real street view images obtained by the location image generation module 115 or the image generation module 120, as an example.

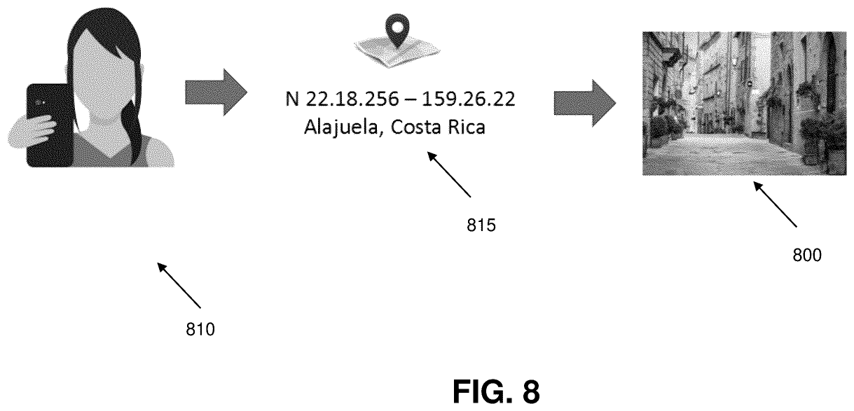

In still other alternate embodiments, the image generation module 120 may use information obtained from the user's device, which is representative of a familiar location to the user. This information may be represented as an image 800 shown in FIG. 8. As previously noted, this familiar location may be obtained from the user 810 by querying a travel history, contact information, transaction history on a credit card or debit card or other information about a location known to the user as queried from their device history. The information may be converted to a coordinate system 815 and then the image 800, itself. In an aspect of the present invention, the image 800 may be an actual street view image or a representative image of such as already described herein.

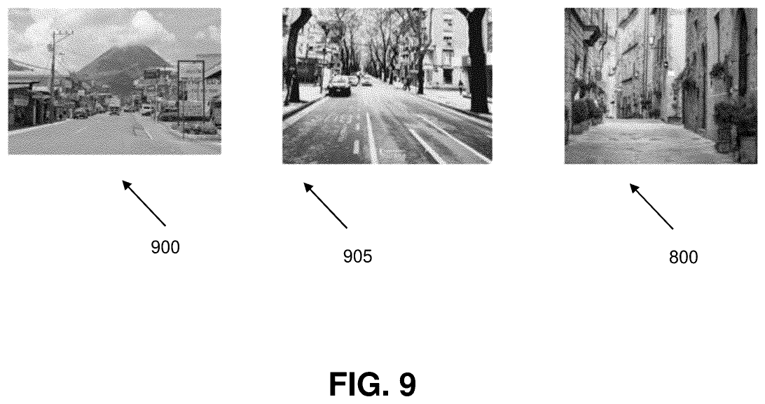

In any of the scenarios, the image generation module 120 may generate fake images that are not representative of a location familiar to the user as shown in FIG. 9. For example, FIG. 9 shows the images 900, 905, which are representative of random locations generated or obtained by the image generation module 120; whereas the image 800 may be representative of an actual location of the user (or a location that is familiar to the user as described herein) as shown in FIG. 8. These images 900, 905, 800 may be real street view images obtained by the location image generation module 115 or the image generation module 120, as an example. Alternatively, the images 900, 905, 800 may be generated by the image generation module 120, with the image 800 may be a representation of and recognized as the location of the user.

In any of the above scenarios, the user verification module 125 may be used to verify or validate the user. For example, the user verification module 125 may present the different images to the user and, upon selection by the user, determine whether the correct image was selected, e.g., image that is representative of the user's location or which is familiar to the user. It should be understood by those of skill in the art that an automated bot would not be able to determine which image of the generated images is the correct image that is representative of the user's actual location or a location that is familiar to the user. Accordingly, in this way, the system, method and computer program product can provide a robust cybersecurity solution which will prevent automated bots from accessing an account or system.

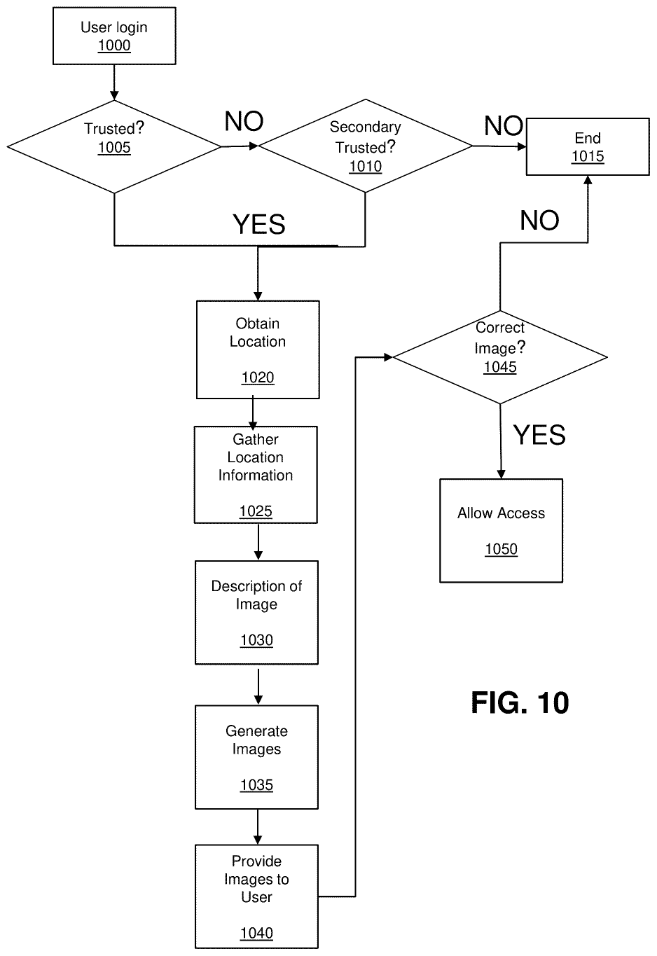

FIGS. 10-12 show different flowcharts of exemplary methods in accordance with aspects of the invention. Steps of the method may be carried out in the environment of FIG. 4 and are described with reference to elements depicted in FIG. 4. It should also be understood that many of the steps shown in FIGS. 10-12 are common to each of the different aspects of the invention.

Referring to FIG. 10, at step 1000, the system recognizes that the user is attempting to log into a system or account. At step 1005, the system determines whether the user is on a trusted device. This verification may be a hardware of digital verification process as described herein. If the device is not trusted, the process continues to step 1010, where a secondary validation determination may be made to determine whether the device is trusted. The secondary determination may be based on MFA, biometrics or an authenticator application. If the secondary determination fails, e.g., the device is not trusted, the process ends at step 1050.

If the device is found to be trusted at steps 1005 or 1010, the system continues to step 1020. At step 1020, the system will obtain the location of the user. This may be done by utilizing the IP address of the device. Should the device be logged in through a VPN, the location information may be found using GPS, for example.

At step 1025, location information will be gathered. This information may be, for example, a street view of the location of the user. At step 1030, the system will translate the street view into a description of the features in the street view. For example, the system may note a particular building, cars, trees, sky, etc., and their relationship to one another. At step 1035, the system will generate a representative image of the street view based on the description of the features, in addition to images that are not representative of the location of the user. These images may be generated using an image-to-image (or text-to-image) generative artificial intelligence (AI) engine.

At step 1040, the system will present all of the images to the user. At step 1045, the system will determine whether the user selected the correct image, e.g., the image that is representative of their location. If the correct image is not selected, the process ends at step 1015. If the selection is the correct image, at step 1050, the user will be allowed to gain access to the system or account.

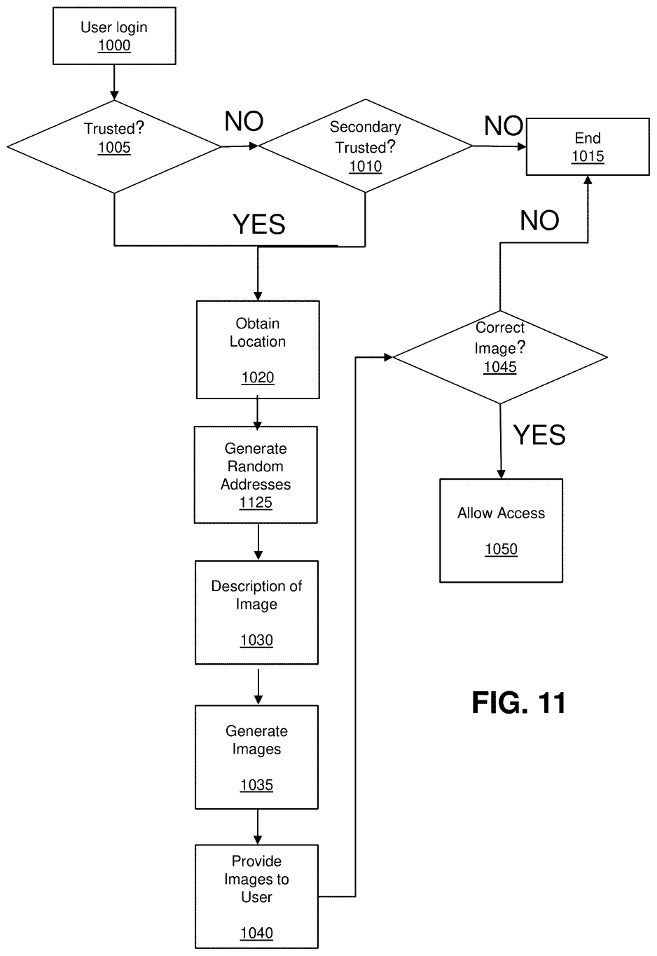

FIG. 11 is a flow based on generating random addresses. For example, after going through the trusted validation process at steps 1005-1020, the system will generate random addresses at step 1125. It should be recognized that one of the random addresses is an address near the user, e.g., at the user's location. At step 1030, the system will again provide a description of the different locations. In the case of using step 1030, the system will use this information to generate different images of the different addresses at step 1035. It should also be recognized that step 1030 is optional. For example, the system can proceed directly to step 1035, where the system can provide the actual images of the different generated address.

In either case, the images will be provided to the user for selection at step 1040. At step 1045, the system will determine whether the user selected the correct image, e.g., the image that is representative of the user's actual location. If the correct image is not selected, the process ends at step 1015. If the selection is the correct image, at step 1050, the user will be allowed to gain access to the system or account.

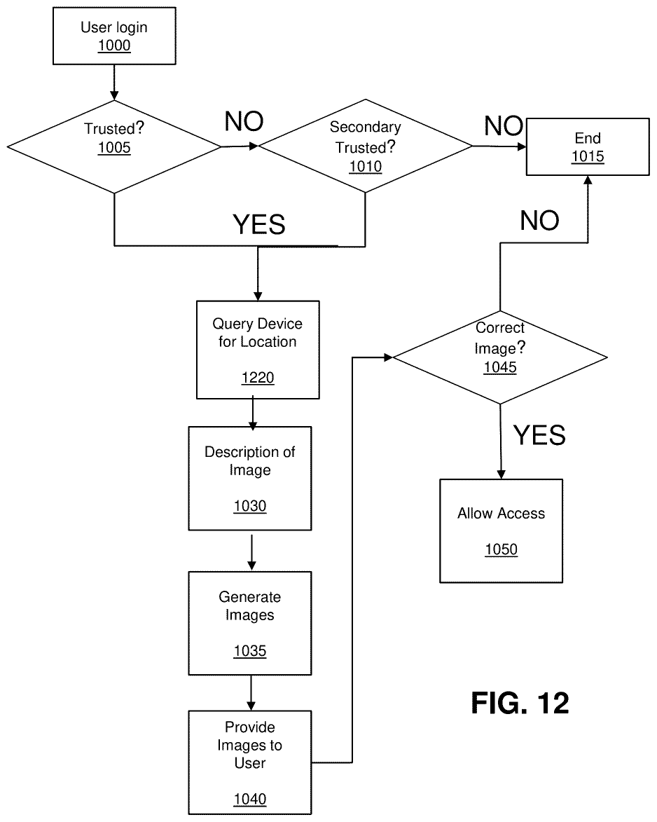

FIG. 12 is a flow based on querying the device for familiar locations of the user. For example, after going through the trusted validation process at steps 1005-1020, the system will query the device for locations familiar to the user at step 1220. The query may be a travel history of the user, metadata from pictures on the user's device, device geolocation, credit card purchases or other transactions, etc. At step 1030, the system will again provide a description of the familiar location. At step 1035, the system will use this information to generate different images of different locations, including an image representative of the familiar location and other locations not familiar to the user. The images will be provided to the user at step 1040 for selection. At step 1045, the system will determine whether the user selected the correct image, e.g., the image that is representative of the familiar location. If the correct image is not selected, the process ends at step 1015. If the selection is the correct image, at step 1050, the user will be allowed to gain access to the system or account.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
obtain, by a computing device, location information of a user attempting to gain access to a system;
generate, by the computing device, a plurality of images from the location information, the plurality of images including at least one image representative of the location of the user;
present, by the computing device, the plurality of images to the user;
validate, by the computing device, the user by determining that the user has selected the at least one image representative of the location information of the user; and
allow, by the computer device, the user to access the system based on the user being validated.

2. The method of claim 1, wherein the system comprises a web-based system.

3. The method of claim 1, wherein the generating the plurality of images includes generating images that are not representative of the location of the user.

4. The method of claim 1, wherein the plurality of images are generated by an image-to-image generative AI engine.

5. The method of claim 1, wherein the plurality of images are generated by a text-to-image generative AI engine.

6. The method of claim 1, wherein the obtaining the location information comprises obtaining one of an IP location of a device used by the user and GPS coordinates of the user.

7. The method of claim 1, wherein the location information represents a location familiar to the user obtained by querying a history of a device used by the user.

8. The method of claim 1, wherein the plurality of images is obtained from a street view of the location information.

9. The method of claim 1, wherein the plurality of images comprises using random addresses, one of which is the location information.

10. The method of claim 1, further comprising validating a device of the user as being a trusted device.

11. The method of claim 10, wherein the validating of the device comprises a hardware validation or a digital validation.

12. The method of claim 10, wherein the validating of the device includes a primary validation and a secondary validation should the primary validation fail.

13. The method of claim 1, wherein the computing device includes software provided as a service in a cloud environment.

14. A computer program product comprising one or more computer readable storage media having program instructions collectively stored on the one or more computer readable storage media, the program instructions executable to:
validate a device as being a trusted device;
determine location information of a user of the device;
generate an image that is representative of the location information of the user and at least one other image that is not representative of the location information of the user;
present to the user the image that is representative of the location information of the user and the at least one other image that is not representative of the location information of the user; and
allow access to a system when the device has been validated as trusted and the user has selected the image that is representative of the location information of the user.

15. The computer program product of claim 14, wherein an image-to-image generative AI engine generates the image that is representative of the location information of the user.

16. The computer program product of claim 14, wherein the location information is a location of the user.

17. The computer program product of claim 14, wherein the location information is a location familiar to the user and obtained by querying the device of a history of the user.

18. The computer program product of claim 14, wherein the validating includes a primary validation and a secondary validation should the primary validation fail.

19. The computer program product of claim 14, wherein the image that is representative of the location information of the user is obtained from a street view of the location information.

20. A system comprising:
a processor, a computer readable memory, one or more computer readable storage media, and program instructions collectively stored on the one or more computer readable storage media, the program instructions executable to:
determine a location of a user using device information;
obtain a picture of the location;
generate an image of the picture that is representative of the location of the user;
present to the user the image that is representative of the location of the user and images of other locations; and
allow access to a system when the user has selected the image that is representative of the location of the user.
